(19) United States
(12) Patent Application Publication
(10) Pub. No.: US 2005/0222365 A1
(43) Pub. Date: Oct. 6, 2005

(54) Process for preparing polyether allophanates using zinc compound catalysts

(75) Inventors: Michael Mager, Leverkusen (DE); Joachim Simon, Dusseldorf (DE); Malte Homann, Odenthal (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/087,249

(22) Filed: Mar. 23, 2005

(30) Foreign Application Priority Data
Apr. 1, 2004 (DE) 102004015983.1

(51) Int. Cl. C08G 18/28

(52) U.S. Cl. 528/73

(57) ABSTRACT

A process for preparing polyisocyanate prepolymers containing allophanate structural units and prepolymers prepared thereby. The process includes the steps of reacting a) one or more aliphatic and/or cycloaliphatic polyisocyanates with b) one or more polyhydroxy compounds to give an NCO-functional polyurethane prepolymer, whose resultant urethane groups are fully or partly allophanatized; reacting the prepolymer with c) polyisocyanates, which may be different from those of a), and using d) zinc(II) compounds as catalysts. The prepolymers can be used to produce coatings, adhesive bonds and/or seals. The coatings can include A) one or more of the prepolymers and B) at least one diol or polyol and/or C) at least one linear and/or cyclic, aliphatic, araliphatic and/or aromatic diamine or polyamine. The coatings can be used to coat substrates.

### CROSS REFERENCE TO RELATED PATENT APPLICATION

The present patent application claims the right of priority under 35 U.S.C. §119 (a)-(d) of German Patent Application No.10 2004 015 983.1, filed Apr. 1, 2004.

### BACKGROUND OF THE INVENTION

1. Field of the Invention

The invention relates to a process for preparing polyisocyanate prepolymers containing allophanate structural units by using zinc compounds as catalysts and also to the use of these for preparing polyurethanes and polyureas.

2. Description of the Prior Art

Polyisocyanate prepolymers containing allophanate structural units are of particular interest on account of their high NCO content at comparatively low viscosity. They constitute useful crosslinkers for two-component polyurethane systems and, with blocked NCO groups, can be used in one-component polyurethane systems as well. Polyurethane systems of this kind are generally used for producing coatings.

Polyisocyanate prepolymers containing allophanate structural units are known in principle.

EP-A 303 150, for example, described a process for preparing aliphatic allophanates which is conducted at high temperatures (>200° C.) without using catalysts. The necessity for rapid heating and the cooling, however, are nigh on impossible to implement in practice, i.e. in the case of large batches.

EP-A 712 840 describes the use of zinc compounds such as zinc stearate, zinc octoate, zinc naphthenate and zinc acetylacetonate as allophanatization catalysts. In this process, though, NCO- and OH-free urethanes are used for the allophanatization. Moreover, the polyisocyanate used for preparing the urethanes must always be different from that used for the (subsequent) allophanatization. The preparation of allophanates based on polyhydroxy compounds such as polyetherpolyols as sole organic hydroxyl compound is not possible by this process.

EP-A 0 682 012 embraces in its description prepolymers based on diisocyanates and polyethers containing 1-4 hydroxyl groups, which can be reacted using tin(II) compounds with an excess of the diisocyanates to give the corresponding allophanates. Tin(II) compounds, however, cannot be adequately deactivated, and so the resulting products shown an increase in viscosity and a decrease in NCO content in the course of storage.

It was an object of the present invention, therefore, to provide a process for preparing (cyclo)aliphatic polyisocyanate prepolymers containing allophanate structural units that leads to products having markedly improved storage stability, especially improved stability of viscosity.

### SUMMARY OF THE INVENTION

The present invention is directed to a process for preparing polyisocyanate prepolymers containing allophanate structural units. The process includes the steps of reacting
a) one or more aliphatic and/or cycloaliphatic polyisocyanates with
b) one or more polyhydroxy compounds to give an NCO-functional polyurethane prepolymer, whose resultant urethane groups are fully or partly allophanatized; reacting the prepolymer with
c) polyisocyanates, which may be different from those of a), and using
d) zinc(II) compounds as catalysts.

The present invention also provides polyisocyanate prepolymers containing allophanate structural units obtained by according to the above-described process.

The present invention additionally provides a method of producing coatings, adhesive bonds and/or seals by combining the above-described polyisocyanate prepolymers containing allophanate structural units with at least one diol or polyol and/or diamine or polyamine.

The present invention further provides coating compositions that include
a) one or more of the above-described polyisocyanate prepolymers containing allophanate structural units and
b) at least one diol or polyol and/or
c) at least one linear and/or cyclic, aliphatic, araliphatic and/or aromatic diamine or polyamine.

The present invention also further provides substrates coated with coatings that contain the above-described polyisocyanate prepolymers containing allophanate structural units.

### DETAILED DESCRIPTION OF THE INVENTION

Other than in the operating examples, or where otherwise indicated, all numbers or expressions referring to quantities of ingredients, reaction conditions, etc. used in the specification and claims are to be understood as modified in all instances by the term “about.” Surprisingly it has now been found that (cyclo)aliphatic polyisocyanate prepolymers containing allophanate structural units can be prepared by conducting the allophanatization with zinc(II)-compounds, preferably zinc alkanoates, as catalysts.

The invention accordingly provides a process for preparing polyisocyanate prepolymers containing allophanate structural units, wherein one or more aliphatic and/or cycloaliphatic polyisocyanates are reacted with one or more polyhydroxy compounds to give an NCO-functional polyurethane prepolymer, whose resultant urethane groups are fully or partly allophanatized with further reaction with polyisocyanates, which may be different from those of a), and zinc(II) compounds as catalysts.

Examples of suitable aliphatic or cycloaliphatic polyisocyanates are di- or triisocyanates such as butane diisocyanate, pentane diisocyanate, hexane diisocyanate (hexamethylene diisocyanate, HDI), 4-isocyanatomethyl-1,8-octane diisocyanate (triisocyanatononane, TIN) or cyclic systems, such as 4,4′-methylenebis(cyclohexyl isocyanate), 3,5,5-trimethyl-1-isocyanato-3-isocyanato-methylcyclohexane(isophorone diisocyanate, IPDI) and also ω,ω′-diisocyanato-1,3-dimethylcyclohexane (H₆XDI), for example.

In components a) and c) it is preferred to use hexane diisocyanate (hexamethylene diisocyanate, HDI), 4,4′-methylenebis(cyclohexyl isocyanate) and/or 3,5,5-trimethyl-1-isocyanato-3-isocyanatomethylcyclohexane(isophorone diisocyanate, IPDI) as polyisocyanates. One especially preferred polyisocyanate is HDI. Preferably the same polyisocyanates are used in a) and c).

As polyhydroxy compounds of component b) it is possible to use any polyhydroxy compounds known to the skilled person, which preferably have an average OH functionality >1.5.

These may be, for example, low molecular weight diols (e.g. 1,2-ethanediol, 1,3- and/or 1,2-propanediol, 1,4-butanediol), triols (e.g. glycerol, trimethylolpropane) and tetraols (e.g. pentaerythritol), polyetherpolyols, polyesterpolyols, polycarbonatepolyols and polythioetherpolyols. Preferred polyhydroxy compounds are polyether-based substances of the aforementioned kind.

Preferably these polyetherpolyols have number-average molecular weights Mₙ of from 300 to 20 000 g/mol, more preferably 1000 to 12 000, very preferably 2000 to 6000 g/mol.

Additionally they preferably possess an average OH functionality of ≧1.9, more preferably ≧1.95.

The OH functionality of these polyethers is preferably <6, more preferably <4. Polyetherpolyols of this kind are obtainable in conventional manner by alkoxylating suitable starter molecules with base catalysis or by using double metal cyanide compounds (DMC compounds).

Particularly suitable polyetherpolyols of component b) are those of the aforementioned kind containing less than or equal to 0.02 milliequivalent of unsaturated end groups per gram of polyol (meq/g), preferably less than or equal to 0.015 meq/g, more preferably less than or equal to 0.01 meq/g (method of determination: ASTM D2849-69).

Polyetherpolyols of this kind have a particularly narrow molecular weight distribution, i.e. a polydispersity (PD=M_{w}/Mₙ) of from 1.0 to 1.5 and/or an OH functionality ≧1.9. The said polyetherpolyols preferably have a polydispersity of from 1.0 to 1.5 and an OH functionality of more than. 1.9, more preferably greater than or equal to 1.95.

Polyetherpolyols of this kind are preparable conventionally by alkoxylating suitable starter molecules, with the use in particular of double metal cyanide catalysts (DMC catalysis). This is described for example in U.S. Pat. No. 5,158,922 (e.g. Example 30) and EP-A 0 654 302 (p. 5, line 26 to p. 6, line 32).

Examples of suitable starter molecules for preparing polyetherpolyols includes simple polyols of low molecular weight, water, organic polyamines having at least two N—H bonds or any desired mixtures of such starter molecules. Alkylene oxides particularly suitable for the alkoxylation are ethylene oxide and/or propylene oxide, which can be used in any order or else in a mixture for the alkoxylation.

Preferred starter molecules for preparing polyetherpolyols by alkoxylation, especially by the DMC method, are simple polyols such as ethylene glycol, propylene 1,3-glycol and butane-1,4-diol, hexane-1,6-diol, neopentyl glycol, 2-ethylhexane-1,3-diol, glycerol, trimethylolpropane, pentaerythritol and low molecular weight, hydroxyl-containing esters of such polyols with dicarboxylic acids, or low molecular weight ethoxylation or propoxylation products of such simple polyols, or any desired mixtures of such polyhydroxy compounds.

The polyurethane prepolymers containing isocyanate groups are prepared by reacting the polyhydroxy compounds of component b) with excess amounts of the polyisocyanates from a). The reaction takes place in general at temperatures of from 20 to 140° C., preferably at 40 to 100° C., with or without the use of catalysts known per se from polyurethane chemistry, such as tin soaps, e.g. dibutyltin dilaurate, or tertiary amines, e.g. triethylamine or diazabicyclooctane.

The allophanatization then takes place subsequently by reaction of the polyurethane prepolymers containing isocyanate groups with polyisocyanates c), which may be identical or different from those of component a), with the addition of suitable catalysts d) for the allophanatization. Subsequently, for the purpose of stabilization, it is possible to add acidic additives as well, before excess polyisocyanate is removed from the product by means for example of thin-film distillation or extraction.

The molar ratio of the OH groups of the compounds of component b) to the NCO groups of the polyisocyanates from a) and c) is preferably 1:1.5 to 1:20, more preferably 1:2 to 1:15, very preferably 1:5 to 1:15.

It is preferred to use zinc(II) alkanoates as catalysts in d). Preferred zinc(II) alkanoates are those based on 2-ethylhexanoic acid and also on the linear, aliphatic C₄ to C₃₀ carboxylic acids. Especially preferred compounds of component d) are Zn(II) bis(2-ethylhexanoate), Zn(II) bis(n-octoate), Zn(II) bis(stearate) or mixtures thereof.

These allophanatization catalysts are used typically in amounts of up to 5% by weight, based on the overall reaction mixture. It is preferred to use from 5 to 500 ppm of the catalyst, more preferably from 20 to 200 ppm.

The acidic additives employed optionally are Lewis acids (electron deficiency compounds) or Brønsted acids (protic acids) or compounds which release such acids on reaction with water.

These may be, for example, organic or inorganic acids or else neutral compounds such as acid halides or esters, which react with water to form the corresponding acids. Mention may be made here in particular of hydrochloric acid, phosphoric acid, phosphoric esters, benzoyl chloride, isophthaloyl dichloride, p-toluenesulphonic acid, formic acid, acetic acid, dichloroacetic acid and 2-chloropropionic acid.

Where acidic additives are used at all they are preferably organic acids such as carboxylic acids or acid halides such as benzoyl chloride or isophthaloyl dichloride.

The aforementioned acidic additives can also be used to deactivate the allophanatization catalyst. Furthermore, they enhance the stability of the allophanates prepared in accordance with the invention, in the case for example of thermal stress during the thin-film distillation or else after preparation, during storage of the products.

The acidic additives are generally added at least in an amount such that the molar ratio of the acidic centres of the acidic additive to deactive centres of the catalyst is at least 1:1. It is, however, preferred to add an excess of the acidic additive.

Thin-film distillation is the preferred method of separating off excess diisocyanate, and it is generally carried out at temperatures from 100 to 160° C. and a pressure of from 0.01 to 3 mbar. The residual monomer content thereafter is preferably less than 1% by weight, more preferably less than 0.5% by weight (diisocyanate).

The process steps in their entirety can be conducted where appropriate in the presence of inert solvents. By inert solvents in this context are meant those which do not react with the reactants under the given reaction conditions. Examples are ethyl acetate, butyl acetate, methoxypropyl acetate, methyl ethyl ketone, methyl isobutyl ketone, toluene, xylene, aromatic or (cyclo)aliphatic hydrocarbon mixtures or any desired mixtures of such solvents. Preferably, however, the reactions of the invention are conducted solventlessly.

The components involved, both during the preparation of the prepolymers containing isocyanate groups and during allophanatization, may be added in any order. It is preferred, however, to add the polyetherpolyol b) to the initially introduced polyisocyanate of components a) and c) and finally to add the allophanatization catalyst d).

In one preferred embodiment of the invention the polyisocyanates of components a) and c) are initially introduced into a suitable reaction vessel and, with stirring where appropriate, are heated at 40 to 100° C. After the desired temperature has been reached the polyhydroxy compounds of component b) are then added with stirring and stirring is continued until the NCO content is at or slightly below the theoretical NCO content of the polyurethane prepolymer which is anticipated in accordance with the chosen stoichiometry. Then the allophanatization catalyst d) is added and the reaction mixture is heated at 50 and 100° C. until the NCO content is at or slightly below the desired NCO content. Following the addition of acidic additives as stabilizers the reaction mixture is cooled or passed on directly to thin-film distillation. In the course of that distillation the excess polyisocyanate is separated off at temperatures from 100 to 160° C. under a pressure of from 0.01 to 3 mbar and to a residual monomer content of less than 1%, preferably less than 0.5%. Following the thin-film distillation it is possible if desired to add further stabilizer.

The allophanates formed in the inventive process correspond typically to the general formula (I) 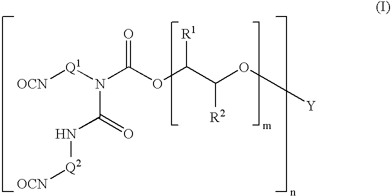
in which
Q¹ and Q² independently of one another are the radical of a linear and/or cyclic aliphatic diisocyanate of the stated kind, preferably —(CH₂)₆—,
R¹ and R² independently of one another are hydrogen or a C₁-C₄-alkyl radical,
R¹ and R² preferably being hydrogen and/or methyl groups,
Y is the radical of a starter molecule of the stated kind having a functionality of from 2 to 6, and hence,
n is a value from 2 to 6, which as a result of the use of different starter molecules need not of course be an integer, and
m preferably corresponds to a number of monomer units such that the number-average molecular weight of the polyether on which the structure is based is 300 to 20 000 g/mol.

The allophanates obtained are preferably compounds corresponding to the general formula (II) 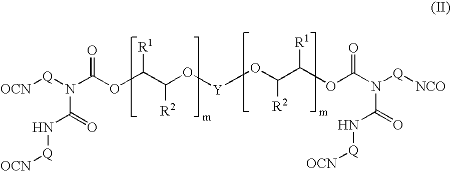
in which
Q is the radical of a linear and/or cyclic aliphatic diisocyanate of the stated kind, preferably —(CH₂)₆—,
R¹ and R² independently of one another are hydrogen or a C₁-C₄-alkyl radical,
R¹ and R² preferably being hydrogen and/or methyl groups,
Y is the radical of a difunctional starter molecule of the stated kind, and
m corresponds to a number of monomer units such that the number-average molecular weight of the polyether on which the structure is based is 300 to 20 000 g/mol.

The allophanates prepared in accordance with the invention typically have number-average molecular weights of from 700 to 50 000 g/mol, preferably 1500 to 15 000 g/mol and more preferably 1500 to 8000 g/mol.

The allophanates prepared in accordance with the invention typically have viscosities at 23° C. of from 500 to 100 000 mPas, preferably 500 to 50 000 mPas, more preferably from 1000 to 7500 mPas and very preferably from 1000 to 3500 mPas.

The products obtainable by the process of the invention are notable in particular for the stability of their viscosity. The viscosity increase after 7 days' storage at 50° C. is preferably less than 10%.

The allophanates of the invention can be used for example for preparing polyurethanes, polyureas or polyurethane-ureas, by reacting them with suitable polyols or polyamines, respectively, or else with a mixture of both. This reaction can take place at room temperature or below, or else at elevated temperatures (baking). The polyurethanes and/or polyureas thus obtained are in turn particularly suitable as a coating.

Accordingly the invention further provides coating compositions which comprise one or more of the allophanates of the invention and at least one diol or polyol and/or at least one linear and/or cyclic, aliphatic, araliphatic and/or aromatic diamine or polyamine.

The allophanates prepared by the process of the invention are notable for their very high compatibility with the aforementioned components B) and C). In particular the combination of A) and C) leads to homogeneous (polyurea) coatings.

The coating compositions referred to can be applied to surfaces by the conventional techniques such as spraying, dipping, flow coating or pouring. After flashing off to remove any solvent present, the coatings then cure under ambient conditions or else at higher temperatures of for example 40 to 200° C.

The said coating compositions can be applied for example to metals, plastics, ceramic, glass and natural substances, it being possible for the said substrates to have been subjected beforehand to any pretreatment that may be necessary.

### EXAMPLES

In the absence of any mention to the contrary, all percentages should be understood as being per cent by weight.

The NCO contents were determined by back-titration of excess added di-n-butylamine with hydrochloric acid.

The viscosities were determined using a rotation viscometer from Haake at 23° C. The colour number was determined in accordance with DIN EN 1557 (Hazen).

### Comparative Example 1

275.5 g of 1,6-hexane diisocyanate were first admixed with 120 mg of a 10% strength solution of isophthaloyl dichloride in n-butyl acetate, after which the mixture was heated with stirring to 100° C. Then, over the course of about 3 hours, 324.3 g were added of a polypropylene glycol which had been prepared by means of DMC catalysis (base-free) (unsaturated groups content <0.01 meq/g, molar weight 2000 g/mol, OH number 56 mg/KOH/g, theoretical functionality 2). The reaction mixture was thereafter heated at 100° C. until an NCO content of 20.7% was reached. Then the temperature was lowered to 90° C. and, following the addition of 50 mg of tin(II) bis(2-ethylhexanoate), the reaction mixture was stirred in order to complete the allophanatization, i.e. down to an NCO content of 18.4%. Using this catalyst, however, the allophanatization was incomplete and even after continued stirring (about 8 hours) an NCO content of only 19.7% was reached.

### Comparative Example 2

275.5 g of 1,6-hexane diisocyanate were heated to 100° C. with stirring. Thereafter, over the course of about 3 hours, 324.4 g were added of a polypropylene glycol which had been prepared by means of DMC catalysis (base-free) (unsaturated groups content <0.01 meq/g, molar weight 2000 g/mol, OH number 56 mg/KOH/g, theoretical functionality 2). The reaction mixture was thereafter heated at 100° C. until an NCO content of 20.7% was reached. Then the temperature was lowered to 90° C. and, following the addition of 50 mg of tin(II) bis(2-ethylhexanoate), the reaction mixture was stirred until the NCO content was 18.4% (about 6 hours). Following the addition of 50 mg of isophthaloyl dichloride the excess 1,6-hexane diisocyanate was removed by means of thin-film distillation at about 0.5 mbar and 140° C.

The allophanatization proceeded almost to completion, and a clear, colourless product was obtained which had an NCO content of 5.47% and a viscosity of 3725 mPas (23° C.).

### Example 1

275.5 g of 1,6-hexane diisocyanate were first admixed with 120 mg of a 10% strength solution of isophthaloyl dichloride in n-butyl acetate, after which the mixture was heated with stirring to 100° C. Then, over the course of about 3 hours, 324.3 g were added of a polypropylene glycol which had been prepared by means of DMC catalysis (base-free) (unsaturated groups content <0.01 meq/g, molar weight 2000 g/mol, OH number 56 mg/KOH/g, theoretical functionality 2). The reaction mixture was thereafter heated at 100° C. until an NCO content of 20.7% was reached. Then the temperature was lowered to 90° C. and, following the addition of 50 mg of zinc(II) bis(2-ethylhexanoate), the reaction mixture was stirred until the NCO content was 18.4% (about 6 hours). Following the addition of 50 mg of isophthaloyl dichloride the excess 1,6-hexane diisocyanate was removed by means of thin-film distillation at about 0.5 mbar and 140° C.

The allophanatization proceeded almost to completion, and a clear, colourless product was obtained which had an NCO content of 5.75% and a viscosity of 3360 mPas (23° C.).

### Example 2

In the same way as in Example 1, 275.5 g of 1,6-hexane diisocyanate and 324.3 g of a polypropylene glycol were reacted in the presence of 50 mg of zinc(II) bis(2-ethylhexanoate) and stabilization was carried out prior to thin-film distillation using 50 mg of isophthaloyl dichloride, but with the difference that no isophthaloyl dichloride was added to the 1,6-hexane diisocyanate.

This this gave a clear, colourless product having an NCO content of 5.75% and a viscosity of 4230 mPas (23° C.).

### Example 3

502.4 g of 1,6-hexane diisocyanate were heated to 100° C. with stirring. Then, over the course of about 3 hours, 297.5 g were added of a polypropylene glycol which had been obtained by means of DMC-catalysis (base-free) (molar weight 1000 g/mol, OH number 112 mg/KOH/g, theoretical functionality 2). The reaction mixture was thereafter heated at 100° C. until an NCO content of 28.2% was reached. Then the temperature was lowered to 90° C. and, following the addition of 70 mg of zinc(II) bis(2-ethylhexanoate), the reaction mixture was stirred until the NCO content was 25.1%. Following the addition of 40 mg of dibutyl phosphate the excess 1,6-hexane diisocyanate was removed by means of thin-film distillation at about 0.5 mbar and 140° C.

This gave a colourless product having a Hazen colour number of 0, NCO content 8.95% of and a viscosity of 3500 mPas (23° C.).

### Example 4

336.0 g of 1,6-hexane diisocyanate were first admixed with 120 mg of a 10% strength solution of isophthaloyl dichloride in n-butyl acetate, after which the mixture was heated with stirring to 100° C. Then, over the course of about 3 hours, 263.8 g were added of a polypropylene glycol which had been prepared by means of DMC catalysis (base-free) (unsaturated groups content <0.01 meq/g, molar weight 2000 g/mol, OH number 56 mg/KOH/g, theoretical functionality 2). The reaction mixture was thereafter heated at 100° C. until an NCO content of 26.1% was reached. Then the temperature was lowered to 90° C. and, following the addition of 50 mg of zinc(II) bis(2-ethylhexanoate), the reaction mixture was stirred until the NCO content was 24.3%. Following the addition of 50 mg of isophthaloyl dichloride the excess 1,6-hexane diisocyanate was removed by means of thin-film distillation at 0.6 mbar and 140° C.

This gave a colourless, clear product have an NCO content 6.45% and a viscosity of 2860 mPas (23° C.).

### Example 5

50 g of each of the allophanates prepared according to Comparative Example 2 and Example 1 were stored in a tightly sealed glass bottle in a drying cabinet at 50° C. As can be seen from the values below, the viscosity of the inventively prepared allophanate rose only slightly (<8%) and the NCO content showed virtually no decrease (<2.1%), whereas the sample prepared using the tin catalyst showed a large increase in viscosity (˜50%):

Allophanate from Example 1:

| | 0 days | 7 days | 14 days |
|---|---|---|---|
| NCO content [%] | 5.75 | 5.71 | 5.63 |
| Viscosity (23° C.) [mPas]: | 3360 | 3440 | 3620 |

Allophanate from Comparative Example 2:

| | 0 days | 7 days | 14 days |
|---|---|---|---|
| NCO content [%] | 5.47 | 5.31 | 5.29 |
| Viscosity (23° C.) [mPas]: | 3725 | 4400 | 5570 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A process for preparing polyisocyanate prepolymers containing allophanate structural units, comprising reacting:
a) one or more aliphatic and/or cycloaliphatic polyisocyanates with
b) one or more polyhydroxy compounds to give an NCO-functional polyurethane prepolymer, whose resultant urethane groups are fully or partly allophanatized; reacting the prepolymer with
c) polyisocyanates, which may be different from those of a), and using
d) zinc(II) compounds as catalysts.

2. The process for preparing polyisocyanate prepolymers containing allophanate structural units according to claim 1, wherein polyisocyanates of the same type are used in components a) and c).

3. The process for preparing stabilized polyisocyanate prepolymers containing allophanate structural units according to claim 1, wherein hexamethylene diisocyanate is used as polyisocyanate in components a) and c).

4. The process for preparing polyisocyanate prepolymers containing allophanate structural units according to claim 1, wherein polyetherpolyols are used in component b).

5. The process for preparing polyisocyanate prepolymers containing allophanate structural units according to claim 1, where in component d) as zinc catalysts for the allophanatization zinc(II) alkanoates based on 2-ethylhexanoic acid and/or on the linear, aliphatic C₄ to C₃₀ carboxylic acids are used.

6. Polyisocyanate prepolymers containing allophanate structural units obtained by a process according to claim 1.

7. A method of producing coatings, adhesive bonds and/or seals comprising combining the polyisocyanate prepolymers containing allophanate structural units according to claim 6 with at least one diol or polyol.

8. Coating compositions comprising
a) one or more polyisocyanate prepolymers containing allophanate structural units according to claim 6 and
b) at least one diol or polyol and/or
c) at least one linear and/or cyclic, aliphatic, araliphatic and/or aromatic diamine or polyamine.

9. Substrates coated with coatings comprising polyisocyanate prepolymers containing allophanate structural units according to claim 6.

10. The process for preparing stabilized polyisocyanate prepolymers containing allophanate structural units according to claim 2, wherein hexamethylene diisocyanate is used as polyisocyanate in components a) and c).

11. The process for preparing polyisocyanate prepolymers containing allophanate structural units according to claim 2, wherein polyetherpolyols are used in component b).

12. The process for preparing polyisocyanate prepolymers containing allophanate structural units according to claim 2, where in component d) as zinc catalysts for the allophanatization zinc(II) alkanoates based on 2-ethylhexanoic acid and/or on the linear, aliphatic C₄ to C₃₀ carboxylic acids are used.

13. Polyisocyanate prepolymers containing allophanate structural units obtained by a process according to claim 2.

14. A method of producing coatings, adhesive bonds and/or seals comprising combining the polyisocyanate prepolymers containing allophanate structural units according to claim 13 with at least one diol or polyol.

15. Coating compositions comprising
a) one or more polyisocyanate prepolymers containing allophanate structural units according to claim 13 and
b) at least one diol or polyol and/or
c) at least one linear and/or cyclic, aliphatic, araliphatic and/or aromatic diamine or polyamine.

16. Substrates coated with coatings comprising polyisocyanate prepolymers containing allophanate structural units according to claim 13.

17. The process for preparing polyisocyanate prepolymers containing allophanate structural units according to claim 3, wherein polyetherpolyols are used in component b) and component d) comprise4s as zinc catalysts for the allophanatization zinc(II) alkanoates based on 2-ethylhexanoic acid and/or on the linear, aliphatic C₄ to C₃₀ carboxylic acids.

18. Polyisocyanate prepolymers containing allophanate structural units obtained by a process according to claim 17.

19. Coating compositions comprising
a) one or more polyisocyanate prepolymers containing allophanate structural units according to claim 18 and
b) at least one diol or polyol and/or
c) at least one linear and/or cyclic, aliphatic, araliphatic and/or aromatic diamine or polyamine.

20. Substrates coated with coatings comprising polyisocyanate prepolymers containing allophanate structural units according to claim 18.
